(19) United States
(12) Patent Application Publication
(10) Pub. No.: US 2011/0161151 A1
(43) Pub. Date: Jun. 30, 2011

(54) METHOD AND APPARATUS FOR DISPENSING ON DEMAND COUPONS

(76) Inventors: Philip Brodie, Long Branch, NJ (US); David Foni, Englewood, NJ (US)

(21) Appl. No.: 12/954,431

(22) Filed: Nov. 24, 2010

Related U.S. Application Data
(60) Provisional application No. 61/283,029, filed on Nov. 25, 2009.

(51) Int. Cl. G06Q 30/00

(52) U.S. Cl. 705/14.25; 705/14.1; 705/14.35

(57) ABSTRACT

An apparatus and related method and system, for dispensing coupons on demand comprising a digital LCD screen for advertisements; a touch screen; a controller unit connected to a network for controlling all internal and external communication to and from the apparatus including a means for providing real time reporting of the coupons dispensed and redeemed; and a printer with a paper supply for printing the coupons; wherein the apparatus permits a user to select desired coupons displayed on said LCD screen or said touch screen and print them on demand. An integrated system for dispensing and redeeming coupons is also provided comprising the apparatus to dispense coupons from a sponsoring manufacturer to a consumer; a data warehouse outside the apparatus which stores consumer information and shopping behavior such that when the consumer uses the apparatus customized coupons based on the users past shopping behavior are presented on the apparatus touch screen; and a point of sale system to redeem coupons; wherein the redeemed coupons are automatically validated and sent to the sponsoring manufacturer for reimbursement.

This application claims the benefit of U.S. provisional application No. 61/283,029 filed Nov. 25, 2009, which is incorporated herein in its entirety by reference.

### FIELD OF THE INVENTION

The present invention relates to an apparatus that provides on demand coupon dispensing for advertised products. Preferably, a kiosk as a stand alone unit, or in combination with a financial services kiosk, is provided to offer users a method to select specific coupon offerings and to print them, as well as personalized coupons based on the behavior and shopping history of the user.

### BACKGROUND OF THE INVENTION

At present, coupons are being offered to the public in magazines and via mailing offerings directly to their houses.

The grocery stores and/or any other retailers are printing them in their own store magazines, offerings and brochures providing a number of coupons for promoted products.

The same is being done by the Consumer Packaged Goods (CPG) companies. They contract with newspapers to provide inserts during the weekend with their particular coupon offerings.

From the retailers' perspective, there are a number of issues and problems with the current offerings. The number of redeemed products using the present advertising methods is only about 1.5% of the total number of coupons provided in the magazines Free Standing Inserts (FSI's). The cost is very high for the results achieved.

It also creates a major problem in controlling inventories, because the retailer does not have a way of managing inventory. They do not know the amounts of products that are going to be redeemed by the customer.

In many cases, the retailer will run out of the advertised products and have to offer rain checks to provide the product at a later date to the customer. Many times this is done at a monetary loss to the retailer because the manufacturers offer for the discounts has expired.

The invention overcomes these issues and problems by the providing an apparatus with the ability to advertise a limited number of offerings in coordination with the manufacturer and the retailer. This provides a way to manage inventories and control the quantity of product offered by using the built in system in the apparatus to provide real time reporting of the number of coupon dispensed and redeemed after the promoted product was purchased.

Various coupon redemption methods are known in the prior art. Representative patents and publications include U.S. Pat. No. 5,905,246 to Fajkowski which provides a system for electronic management and redemption of coupons; U.S. Patent Publication No. 2007/0276727 to Thibedeau which discloses a system for redeeming coupons including a network and a point of sale terminal coupled to the network; and U.S. Pat. No. 5,844,221 to Madigan which discloses a method and system for redeeming coupons having a barcode thereon. In particular, U.S. Pat. No. 6,536,663 B1 to Lozier et al. discloses a voucher-dispensing kiosk and an ATM. The kiosk is for use at retail locations and performs financial services, such as cashing checks. Lozier does not however disclose on demand dispensing of coupons.

Unlike the prior art, the invention system provides the customer the ability to review an on screen illustration of offered coupons and the particular discounts provided. The customer will then be able to choose the particular coupons they want and print the selected coupons.

The coupons dispensed are being offered for a limited time and the information is clearly depicted on the coupon. The redemption is being processed at the Point of Sale (POS) and the particular data is saved and the system is able to inquiry it at any time.

A loyalty card can be inserted into the reader at the kiosk and the user is then identified by the system. Additional offerings can then be provided for the specific user. The offering can be related to previous purchases of the user or to the level of purchases the user has done in the past.

In addition to the benefits to the retailer and manufacturer, the invention unit also benefits the consumer by providing an in store offer prior to purchase for discounted products and the ability for on demand dispensing of the respective advertised products on the unit. Without this, the consumer has to clip coupons and has to remember the multitude of products that he or she chooses. The apparatus provides the consumer the ability to choose and the coupons that are relevant for him or her at the particular time he or she is shopping.

The system benefits the retailer and manufacturers by providing them the ability to control inventory levels and be able to change offerings in real time according to the status in a particular location.

Accordingly, it is an object of the invention to provide a device as a stand alone unit or in conjunction with a financial service device, such as an ATM or Bill Pay, to permit the user on demand dispensing of coupons.

A further object of the invention is to provide to customers as they enter a retailers location a way to dispense coupons of products that are being displayed on the digital screen of the unit.

A further object of the invention is to provide the retailer and the manufacturer a way of offering their customers products relevant to the specific location, particular time of day, outside weather and traffic in the location area.

Yet still a further object of the invention is to provide the retailer and manufacture the ability to change the coupon offerings in real time and also have real time feedback in the redemption process.

### SUMMARY OF THE INVENTION

In the present invention, these purposes, as well as others which will be apparent, are achieved generally from an apparatus for dispensing coupons on demand comprising: a digital LCD screen; a touch screen; a controller unit connected to a network for controlling all internal and external communication to and from the apparatus including a means for providing real time reporting of the coupons dispensed and redeemed; a printer with a paper supply for printing the coupons in a specific size and with specific data; wherein the apparatus permits a user to select desired coupons displayed on said LCD screen or said touch screen and print on demand for use at a particular time and location.

In a preferred embodiment the controller unit further comprises an advertisement processer for displaying advertisements on the LCD screen and a separate a transaction processor for completing the desired transaction by the user.

The apparatus also includes, among other components, a bill acceptor, card scanner, card dispenser, a bar code scanner and a magnetic strip reader. The bar code scanner and magnetic strip reader provide the same data to the apparatus.

The invention also provides a method for dispensing coupons on demand using the apparatus described above. Using the touch screen a user selects desired coupons displayed on the touch screen itself of the LCD screen advertisements. The selected coupons include images, text and/or bar codes made by the consumer specific for the selected coupons. The selected coupons by the user are printed and redeemed within a limited time period and at a particular location.

The apparatus is capable of reading credit, debit and/or loyalty cards of a consumer with a magnetic strip to provide the user's information and behavior data to the control unit of the apparatus.

The apparatus is also capable of reading loyalty cards to identify the consumer at the apparatus and provide information to the control unit to provide consumer with special coupon offers according to their shopping history.

The apparatus is in communication with a data warehouse outside the apparatus that stores specific consumer data and provides behavioral analytics to provide the consumer with special coupon offers at a particular location according to their shopping history.

The invention also provides a system for monitoring retailer and manufacturer product inventory levels provided in an apparatus as described above. Using the touch screen on the apparatus a user selects desired coupons displayed on the LCD screen of the touch screen itself. The selected coupons by the users are printed and dispensed from the apparatus. The user redeems the coupons within a particular time period and at a particular location. Upon redemption, information is communicated back to the apparatus in real time at the particular location so as to monitor inventory levels and modify coupons displayed on the LCD screen.

Preferably, the issued coupon has a limited time offer shown on it. It can be redeemed only within the time shown on the coupon.

The system provides tracking of the number of dispensed coupons and the number of redeemed coupons. The apparatus is in communication with a data warehouse outside the apparatus that stores specific user data and provides behavioral analytics. The system distributes the user data to the apparatus at the particular location where the user is to provide customized coupons based on the users past shopping behavior.

An integrated system for dispensing and redeeming coupons is also provided including the invention apparatus to dispense coupons from a sponsoring manufacturer to a consumer; a data warehouse outside the apparatus which stores consumer information and shopping behavior such that when the consumer uses the apparatus customized coupons based on the users past shopping behavior are presented on the apparatus touch screen; and a point of sale system to redeem coupons wherein the redeemed coupons are automatically validated and sent to the sponsoring manufacturer for reimbursement.

The integrated system according to the invention provides an in-store coupon redemption rate of approximately 30% of the dispensed coupons.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a flow chart illustration of the apparatus components and logic of the invention;

FIG. 2A is an illustration of the apparatus according to the invention showing the internal components; FIG. 2B is an illustration of the apparatus according to the invention showing the external surface; and

FIG. 3 is a flow chart of the integrated system of the invention including the apparatus, data warehouse and point of sale system.

### DETAILED DESCRIPTION OF THE INVENTION

In accordance with the present invention a system for on demand dispensing of coupons is provided. The invention apparatus is preferably a kiosk that can be an integral part of financial services kiosk, such as an ATM, or as a stand alone unit. The system offers coupons via its digital display screen and the user can choose a specific offering or all of them on that particular kiosk and then print the desired coupons.

The user can get the coupons at the kiosk and redeem them in the store at the POS for the appropriate discounts when he/she fulfills the requirements as stated on the offering. The coupons time and date stamped as well uniquely identifiable by a bar code or any other markings on them. They are valid for the specific time frames only.

The kiosk system can identify the user by its loyalty card in each particular store or within the same store chain, and offer special/additional coupons.

The system can include a digital sign (LCD) that the offerings are shown on, a touch screen, where the user makes his choices and inputs his information. The digital signage is an overhead screen on the apparatus which is readily seen by consumers. The LCD screen supports all standardized media types used in today's print media, television and web based offerings. The touch screen also provides in-store couponing based on day, time of day, or customer specific. Store locations can promote bakery, deli, private label items or issue coupons for national, regional and local consumer packaging goods manufacturing opportunities.

The apparatus incorporates a printer that prints the coupons, a bar code reader that can read loyalty cards and UPC codes, a magnetic strip reader that can read a debit card or credit card or any other card that has information on a magnetic strip.

The apparatus also includes one or more PC's (CPUs) that can control, store information and manage all functions of the unit. It communicates with the appropriate computer to receive updates on the offerings in real time and to display them on the upper (LCD) screen. It is capable of accessing data bases to verify the status of the loyalty card and it has the ability to enroll a new customer in a loyalty card program for the specific store where it is being used.

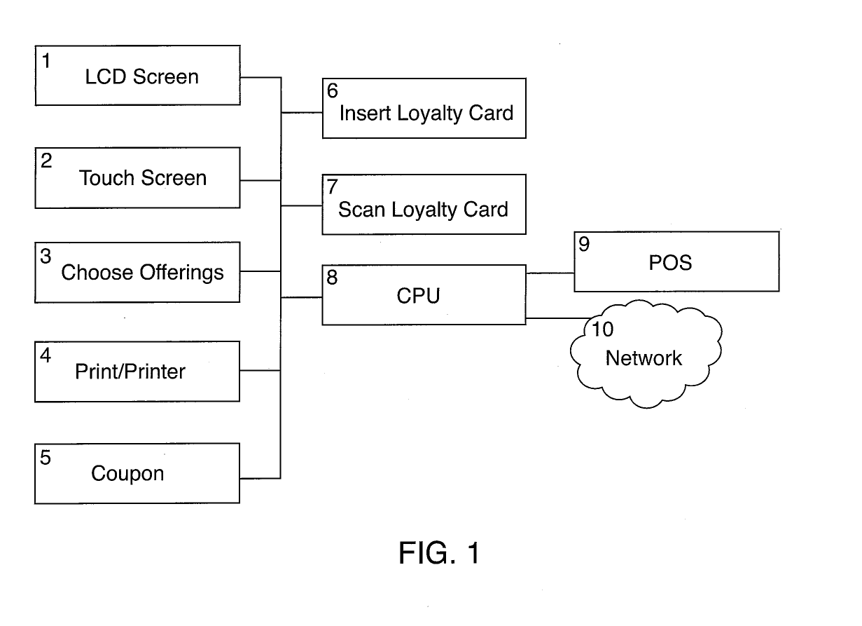

FIG. 1 is a flow chart illustration of the apparatus components and logic of the invention. Each component is described in more detail below.

Component 1 depicts the digital advertisement screen (LCD). Preferably, it is located on top of the unit that provides the offerings for coupons or any other promotions for the physical location of the unit.

Component 2 depicts the touch screen that the user/customer can tap and choose the specific coupons to be printed. The screen is also used for advertisement and for inputting information into the system.

Component 3 is the “Offering Choosing” mechanism which is a system that keeps track of all the coupons that the user opts to print.

Component 4 of the invention unit is equipped with a printer that receives its commands from the CPU and prints individual coupons, or a consolidated one, for the chosen coupons by the user. It prints text and images, as well as, bar codes.

Component 5 is the coupon itself. The coupon is issued to the user after it is printed by the printer (Component 4). It includes images, text and bar codes to depict the choices made by the specific customer for the chosen coupons.

Component 6 is a magnetic strip card reader, capable of reading all Credit and Debit cards and Loyalty cards with a magnetic strip. It provides the information to the CPU (Component 8).

Component 7 is a Bar Code scanner that can read all types of Bar Codes in order to identify and provide the information to the CPU (Component 8). The Bar Code reader can identify a specific Loyalty card and its owner by its unique number. The information is passed to the CPU and is printed on the coupon. The loyalty card identifies the user and special offers can be presented to him or her according to their shopping history.

Component 8 is the CPU controller or a PC that is controlling all internal and external communication and devices with the unit. It communicates with all the peripherals internally: LCD Screen (1), Touch Screen (2), Printer (4), Choosing Offerings (3), Magnetic Strip Reader (6), Bar Code Reader (7) and provides information or returning information from the device in order to provide the information required.

The CPU also communicates with the outside sources and controlling devices such as:
A. Point of Sales (POS) from whom it receives the redemption information.
B. Servers that control the schedule for advertisements.
C. Remote control and management.
D. Internet
E. Server that uploads current coupon offers and provides management for them.
F. Loyalty card data base and registration.

Component 9 is the POS, Point of Sales, which is the system that the location is using for registering the sale. It scans the items, looks into the data base and provides pricing for the items, it reads the coupons and applies the appropriate discounts. It also looks for the user's loyalty card number and will apply discounts, give points, and can provide additional offerings prepared specifically to the holder of the Loyalty card.

The invention provides means to interface to the system and receive or provide the appropriate information for issuing the coupons and identifying the user via the loyalty card. The POS is typically an existing product that the invention interfaces to.

Component 10 is the network and is the means the apparatus communicates with the outside world. The network be a local network, the Internet, Wireless or any other means of communications.

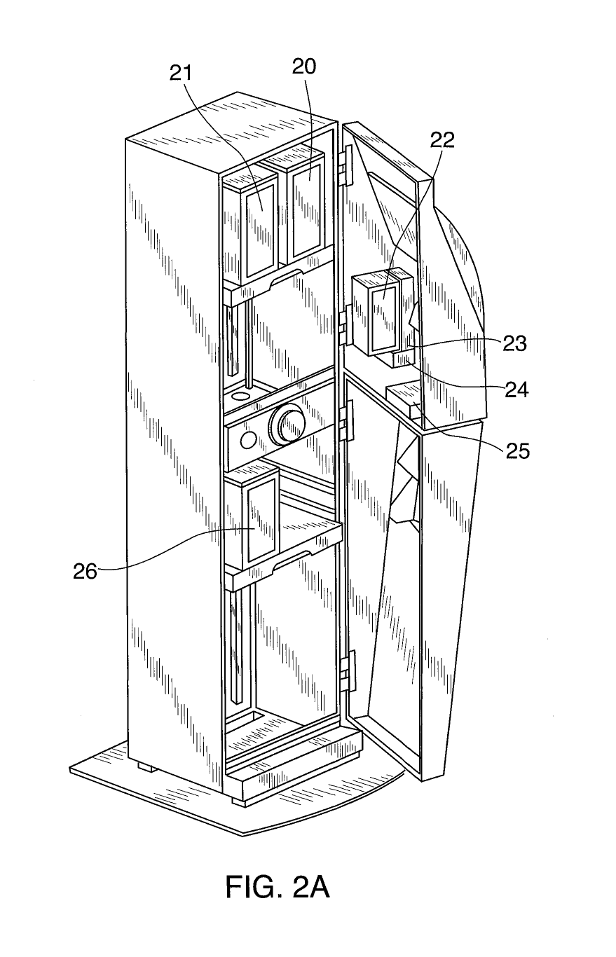

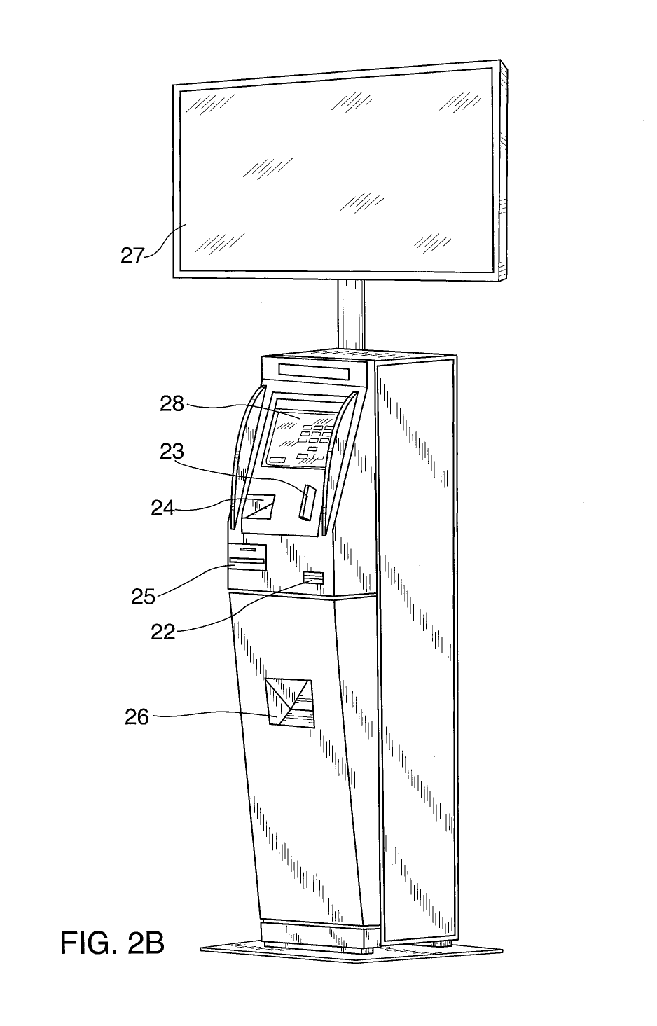

FIG. 2A is an illustration of the apparatus according to the invention showing the internal components. Specifically shown are the advertisement PC 20; the transaction PC 21; the bill acceptor 22; the card reader 23; the barcode scanner 24; the thermal receipt printer 25 and the card dispenser 26.

FIG. 2B is an illustration of the apparatus according to the invention showing the external surface. Specifically, shown are the LCD screen 27; touch screen 28. The card reader 23; the barcode scanner 24; the thermal receipt printer 25; the bill acceptor 22 and card dispenser 26 are also shown.

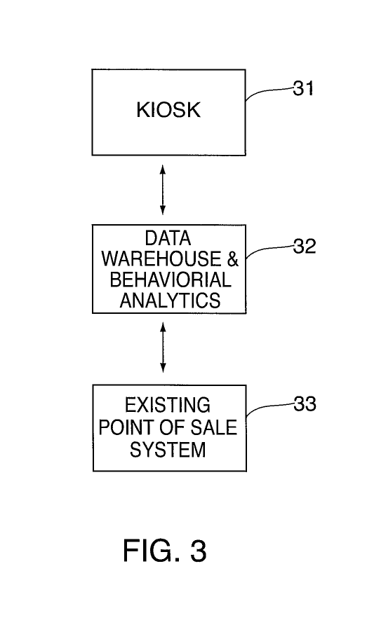

FIG. 3 is a flow chart of the integrated system of the invention including the apparatus 31, data warehouse 32 and point of sale system 33. The data warehouse stores consumer data and provides behavioral analytics on the individual apparatus consumer to provide customized and personal coupons based on the consumers habits and past shopping history. The system is fully integrated into existing point of sale systems at store locations.

For example, as customers select coupons and offers on the apparatus, they are coupled to the customer's card number and injected directly into the locations existing point of sale. As customers items are scanned, e-coupons and discounts are applied in real-time during checkout. Coupons are automatically validated and sent to the sponsoring manufacturer for reimbursement.

Apparatus content can be programmed individually to provide targeted messaging and couponing based on customer behavioral analysis as well as specific store metrics.

The apparatus provides the ability to process coupons and provide loyalty enrollment cards for a loyalty program designed for specific stores. They also provide consumers with information and functionality needed to redeem coupons for obtaining immediate discounts in store. The digital signage screens attached to the apparatus provide advertising opportunities for both national and local advertisers.

The apparatus according to the invention are preferably located in supermarkets and display promoted products on the digital screen as well as providing the ability to redeem coupons in order to purchase at a discounted rate. The invention system tracks the number of dispensed coupons as well as calculates the rebates that the store is due. The upper screen on the apparatus is used as a tool to advertise store promotions and has an interface allowing the local store to display and show special promotions. It receives its information from central servers that distributes the data to specific locations as required. The loyalty enrollment program and dispensing of loyalty cards is designed to automate the manual function proved by the store employees and allow the system to gather information on specific purchase trends.

The apparatus of the invention provides in-store product advertising and on-demand coupons. The in-store coupons have a redemption rate of nearly 30%, compared to a rate of 1.4% for traditional coupon mediums.

A preferred apparatus has a 32 inch advertisement screen, a 15 inch touch screen interface, an 80 mm thermal coupon printer, a CCD bar code reader, a loyalty card dispenser, a dual mag-stripe card reader. The apparatus is capable of multiple languages and is designed to work in conjunction with existing ATM placements.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. An apparatus for dispensing coupons on demand comprising:
a digital LCD screen for advertisements;
a touch screen;
a controller unit connected to a network for controlling all internal and external communication to and from the apparatus including a means for providing real time reporting of the coupons dispensed and redeemed; and
a printer with a paper supply for printing the coupons;
wherein the apparatus permits a user to select desired coupons displayed on said LCD screen or said touch screen and print them on demand.

2. The apparatus according to claim 1, wherein said controller unit further comprises an advertisement processer for displaying advertisements on said LCD screen.

3. The apparatus according to claim 1, wherein said controller unit further comprises a transaction processor for completing the desired transaction by the user.

4. The apparatus according to claim 1, further comprising a bill acceptor.

5. The apparatus according to claim 1, further comprising a card scanner.

6. The apparatus according to claim 1, further comprising a card dispenser.

7. The apparatus according to claim 1, further comprising a bar code scanner.

8. The apparatus according to claim 1, further comprising a magnetic strip reader.

9. A method for dispensing coupons on demand comprising:
providing an apparatus according to claim 1;
selecting coupons by a consumer using said touch screen on the apparatus to select desired coupons displayed on said LCD screen or touch screen; and
printing selected coupons; wherein the selected coupons include images, text and bar codes made by said consumer specific for the selected coupons which are redeemed by the consumer within a particular time period and at a particular store location.

10. The method according to claim 9, further comprising reading credit, debit and/or loyalty cards of a consumer with a magnetic strip to provide the users information and behavior data to said control unit.

11. The method according to claim 9, further comprising reading loyalty cards to identify the consumer at the apparatus and provide information to said control unit to provide consumer with special coupon offers according to their shopping history.

12. The method according to claim 9, wherein the apparatus is in communication with a data warehouse outside the apparatus that stores specific consumer data and provides behavioral analytics to provide the consumer with special coupon offers at a particular location according to their shopping history.

13. A system for monitoring retailer and manufacturer product inventory levels comprising:
providing an apparatus according to claim 1;
selecting coupons by a user using said touch screen on the apparatus to select desired coupons displayed on said LCD or touch screen;
dispensing and printing said selected coupons from the apparatus;
redeeming said coupons within a particular time period and at a particular location; wherein the coupon redemption information is communicated back to said apparatus in real time at a particular location to control inventory levels and to modify coupons displayed on the LCD screen for selection by the user.

14. The system according to claim 13, further comprising tracking of the number of dispensed coupons.

15. The system according to claim 13, further comprising tracking the number of redeemed coupons.

16. The system according to claim 13, further comprising calculating the rebates due a particular store from the dispensed coupons.

17. The system according to claim 13, wherein the apparatus is in communication with a data warehouse outside the apparatus that stores specific user data and provides behavioral analytics.

18. The system according to claim 17, distributing said user data to the apparatus at the particular location where the user is to provide customized coupons based on the users past shopping behavior.

19. An integrated system for dispensing and redeeming coupons comprising:
providing an apparatus according to claim 1 to dispense coupons from a sponsoring manufacturer to a consumer;
providing a data warehouse outside the apparatus which stores consumer information and shopping behavior such that when the consumer uses the apparatus customized coupons based on the users past shopping behavior are presented on the apparatus touch screen; and
providing a point of sale system to redeem coupons;
wherein the redeemed coupons are automatically validated and sent to the sponsoring manufacturer for reimbursement.

20. The integrated system according to claim 19, providing an in-store coupon redemption rate of approximately 30% of the dispensed coupons.
